(19) United States
(12) Patent Application Publication
(10) Pub. No.: US 2026/0270404 A1
(43) Pub. Date: Sep. 10, 2026

(54) TEMPLATE MATCHING BASED MOTION VECTOR REFINEMENT IN VIDEO CODING SYSTEM

(71) Applicant: MediaTek Singapore Pte. Ltd., Singapore (SG)

(72) Inventors: Olena CHUBACH, San Jose, CA (US); Chun-Chia CHEN, Hsinchu City (TW); Man-Shu CHIANG, Hsinchu City (TW); Tzu-Der CHUANG, Hsinchu City (TW); Ching-Yeh CHEN, Hsinchu City (TW); Chih-Wei HSU, Hsinchu City (TW); Yu-Wen HUANG, Hsinchu City (TW)

(21) Appl. No.: 19/660,572

(22) Filed: Apr. 28, 2026

Related U.S. Application Data
(62) Division of application No. 18/684,798, filed on Aug. 18, 2022.
(60) Provisional application No. 63/234,730, filed on Aug. 19, 2021.

(51) Int. Cl. H04N 19/105; H04N 19/119; H04N 19/146; H04N 19/176; H04N 19/196; H04N 19/513

(52) U.S. Cl. CPC H04N 19/105; H04N 19/119; H04N 19/146; H04N 19/176; H04N 19/196; H04N 19/513; H04N 19/521

(57) ABSTRACT

A video encoder or a video decoder may perform operations to determine an initial motion vector (MV) such as a control point motion vector (CPMV) candidate according to an affine mode or an additional prediction signal representing an additional hypothesis motion vector, for a current sub-block in a current frame of a video stream; determine a current template associated with the current sub-block in the current frame; retrieve a reference template within a search area in a reference frame; and compute a difference between the reference template and the current template based on an optimization measurement. Additional operations performed may include iterating the retrieving and the computing the difference for a different reference template within the search area until a refinement MV, such as a refined CPMV or refined additional hypothesis motion vector, is found to minimize the difference according to the optimization measurement.

### CROSS REFERENCE TO RELATED APPLICATIONS

The present application is a Divisional of pending U.S. application Ser. No. 18/684,798, filed on Feb. 19, 2024, which is a 371 National Phase of pending Application No. PCT/CN2022/113388, filed on Aug. 18, 2022, which claims priority to U.S. provisional patent application No. 63/234,730, filed on Aug. 19, 2021. The U.S. provisional patent application is hereby incorporated by reference in its entirety.

### BACKGROUND

### Field

The described disclosure generally relates to motion compensation for video processing methods and apparatuses in a video coding system, including template matching based motion vector refinement for motion compensation in video encoding and decoding systems.

### Related Art

Digital video systems have found applications in various devices and multimedia systems such as smartphones, digital TVs, digital cameras, and other devices. Techniques for digital video systems are generally governed by various coding standards such as H.261, MPEG-1, MPEG-2, H.263, MPEG-4, and advanced video coding (AVC)/H.264. The high efficiency video coding (HEVC) is a standard developed by the Joint Collaborative Team on Video Coding (JCT-VC) group based on a hybrid block-based motion-compensated transform coding architecture. The HEVC standard improves the video compression performance of its preceding standard AVC to meet the demand for higher picture resolutions, higher frame rates, and better video qualities. In addition, versatile video coding (VVC), also known as H.266, is a successor of HEVC. VVC is a video compression standard with improved compression performance and support for a very broad range of applications. However, with the ever increasing demand for high quality and high performance digital video systems, improvements on video coding, such as video encoding and decoding, over the current standards such as VVC and HEVC, are desired. The following publication related to versatile video coding algorithms and specification is available from Signal Processing Society website (https://signalprocessingsociety.org/sites/default/files/uploads/community_involvement/docs/ICME2020_MMSPTC_VideoSlides_Versatile_Video_Coding.pdf), which is hereby incorporated by reference in its entirety,

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIGS. 1-3 illustrate an example video coding system for performing template matching on a search area of a reference frame to find a refinement of an initial motion vector for motion compensation, according to some aspects of the disclosure.

FIGS. 4A-4B illustrate example control point motion vectors (CPMV) for a sub-block in a frame of a video stream according to an affine mode, according to some aspects of the disclosure.

FIG. 5-6 illustrate an example template matching process performed on a search area of a reference frame to find a refinement of an initial motion vector for motion compensation, according to some aspects of the disclosure.

FIGS. 7-8 illustrate another example template matching process performed on a search area of a reference frame to find a refinement of motion vectors for motion compensation, according to some aspects of the disclosure.

FIG. 9 is an example computer system for implementing some aspects or portion(s) thereof of the disclosure provided herein.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition does not in itself dictate a relationship between the various embodiments and/or configurations discussed.

### Overview

Some aspects of this disclosure relate to apparatuses and methods implemented in a video encoder or a video decoder in a video coding system. A method implemented in a video encoder or a video decoder may include determining a control point motion vector (CPMV) candidate for a current sub-block or a block in a current frame of a video stream according to an affine mode; determining a current template associated with the current sub-block in the current frame; retrieving a reference template generated by an affine motion vector field within a search area in a reference frame; and computing a difference between the reference template and the current template based on an optimization measurement. In addition, the method may further include iterating the retrieving, and computing the difference, for a different reference template within the search area until a refinement CPMV is found to minimize the difference according to the optimization measurement. The optimization measurement may be a sum of the absolute differences (SAD) measurement or a sum of squared differences (SSD) measurement. The method can further include applying motion compensation to the current sub-block using the refinement CPMV to encode or decode the current sub-block.

Some aspects of this disclosure relate to a video decoder including an apparatus for motion compensation in the video decoder. The apparatus can include one or more electronic devices or processors configured to perform motion compensation operations related to template matching. In some embodiments, the one or more electronic devices or processors can be configured to receive input video data associated with a current block in a current frame including multiple sub-blocks, where the video data includes a control point motion vector (CPMV) candidate for a current sub-block of the current block in the current frame according to an affine mode; determine a current template associated with the current sub-block in the current frame; retrieve a reference template generated by an affine motion vector field within a search area in a reference frame; and compute a difference between the reference template and the current template based on an optimization measurement. In addition, the one or more electronic devices or processors can be configured to iterate the retrieving and computing the difference for a different reference template within the search area until a refinement CPMV is found to minimize the difference according to the optimization measurement. Furthermore, the one or more electronic devices or processors can be configured to apply motion compensation to the current sub-block using the refinement CPMV to decode the current sub-block.

Some aspects of this disclosure relate to a video decoder including an apparatus for motion compensation (MC) in the video decoder. The apparatus can include one or more electronic devices or processors configured to perform motion compensation operations related to template matching. In some embodiments, the one or more electronic devices or processors can be configured to determine a conventional prediction signal representing an initial prediction P₁ for a current sub-block; determine an additional prediction signal representing an additional hypothesis prediction hₙ₊₁ for the current sub-block. Afterwards, the one or more electronic devices or processors can be configured to perform a template matching based refinement process for a motion vector MV(hₙ₊₁) used to obtain the additional hypothesis prediction hₙ₊₁ within a search area in a reference frame for a current template associated with the current sub-block until a best refinement of the additional hypothesis prediction h′ₙ₊₁=MC(TM(MV(hₙ₊₁))) is found according to an optimization measurement. Furthermore, the one or more electronic devices or processors can be configured to derive an overall prediction signal Pₙ₊₁ by applying a sample-wise weighted superposition of at least a prediction signal obtained by the best refinement of the MV used for deriving additional hypothesis prediction h′ₙ₊₁=MC(TM(MV(hₙ₊₁))) based on a weighted superposition factor αₙ₊₁.

### Video Encoding/Decoding

In a video coding system, a video sequence including multiple frames can be transmitted in various forms from a source device to a destination device of the video coding system. In order to improve the communication efficiency, not every frame is transmitted. For example, a reference frame may be transmitted first, but a current frame may not be transmitted entirely. Instead, a video encoder of the source device may find the redundant information between the reference frame and the current frame, further encode and transmit video data indicating the difference between the current frame and the reference frame. In some embodiments, the current frame can be split into a plurality of blocks, where a block can be further split into multiple sub-blocks. In some embodiments, a block or a sub-block can be a coding tree unit (CTU), or a coding unit (CU). The transmitted video data, which can be referred to as a prediction signal, can include a motion vector (MV) to indicate the difference at the block or sub-block level between the current frame and the reference frame. In some embodiments, prediction operations can be performed by the video encoder to find redundant information within the current frame (intra-prediction) or between the current frame and the reference frame (inter-prediction), and compress the information into a prediction signal indicating the difference represented by the video data including the MV. At the receiving side, a video decoder of the destination device can perform operations including predictions to reconstruct the current frame based on the reference frame and the received prediction signal, e.g., the video data including the MV indicating the difference between blocks or sub-blocks of the current frame and the reference frame.

In some embodiments, a MV included in the prediction signal or the video data can indicate the difference at the block or sub-block level between the current frame and the reference frame. However, it may be costly to find the exact difference at the block or sub-block level between the current frame and the reference frame. In some embodiments, a MV candidate can be an initial MV to indicate an approximation of the difference at the block or sub-block level between the current frame and the reference frame. The MV candidate or the initial MV may be generated and transmitted by a video encoder of the source device, while a video decoder of the destination device can perform operations to refine the initial MV or the MV candidate to derive the MV itself, or the refinement MV, indicating the difference at the block or sub-block level between the current frame and the reference frame.

A MV or a MV candidate can be specified based on a motion model, which can include a translational motion model, an affine motion model, or some other motion model. For example, the motion model of the conventional block-based motion compensation in High Efficiency Video Coding (HEVC) is a translational motion model. In the translational motion model, one MV included in a uni-prediction signal may be enough to specify the difference between a sub-block of a current frame and a sub-block of a reference frame caused by some rigid movements in a linear fashion. In some embodiments, two MVs with respect to two reference frames included in a bi-prediction signal may be used as well. However, in the real world, there can be many kinds of motions besides rigid or linear movements. In Versatile Video Coding (VVC), a block-based 4-parameter and 6-parameter affine motion model can be applied, where 2 or 3 MVs can be used to specify various movements such as rotation or zooming for the current frame with respect to one reference frame. For example, a block-based 4-parameter affine motion model can specify movements such as rotation and scaling with respect to one reference frame, while a block-based 6-parameter affine motion model can specify movements such as aspect ratio, shearing, in addition to rotation and scaling with respect to one reference frame. In an affine motion model, a MV can refer to a control point motion vector (CPMV), where a CPMV is a MV at various control points of a sub-block or a block. For example, a sub-block can have 2 or 3 CPMV in the affine motion model, where each CPMV can also be referred to as a MV since each CPMV is a MV at some specific location or a control point. Descriptions herein related to MV can be applicable to CPMV, and vice versa.

Under the affine motion model where a MV can refer to a CPMV, the video coding system may operate in various operation modes such as an affine inter mode, an affine merge mode, an advanced motion vector prediction (AMVP) mode, or some other affine modes. An operation mode, such as an affine inter mode or an affine merge mode, may specify how a CPMV or a CPMV candidate is generated or transmitted. When the video coding system operates in the affine inter mode, the CPMVs or CPMV candidates of a sub-block can be generated and signaled from the source device to the destination device directly. Affine inter mode can be applied for CUs with both width and height larger than or equal to 16. In some embodiments, the video coding system may operate in an affine merge mode, where CPMVs or CPMV candidates of a sub-block are not generated by the source device and signaled from the source device to a destination device directly, but generated from motion information of spatial or collocated neighbor blocks of the sub-block by the video decoder of the destination device of the video coding system.

In some embodiments, regardless of whether the motion model is a translational motion model, an affine motion model, multiple MVs, e.g., more than one MV in the conventional uni-prediction or more than two MVs in the conventional bi-prediction signal, can be used to indicate the difference at the block or sub-block level between the current frame and the reference frame. Such multiple MVs, which may be used for obtaining a multiple hypothesis prediction hₙ₊₁, can be used to improve the accuracy of the sub-block decoded by the video decoder. When multiple hypothesis predictions hₙ₊₁ are used, the video decoder may apply a linear and iterative formula Pᵢ=(1−αᵢ) Pᵢ₋₁+αᵢ hᵢ to derive the final predictor having improved accuracy compared to the traditional decoding approach where only one MV is used in the uni-prediction signal or two MVs are used in the bi-prediction prediction signal.

In some embodiments, when a MV candidate is included in the prediction signal received from a video encoder of the source device by a video decoder of the destination device, the video decoder of the destination device can perform refinement operations to derive a refinement MV based on the MV candidate to indicate the real difference at the block or sub-block level between the current frame and the reference frame.

In some embodiments, a refinement MV can be derived by various techniques. For example, a template matching (TM) process can be applied to find the refinement MV for a MV candidate. When the TM process is applied, a current template of the current sub-block in the current frame can be found first, a reference template can be generated at the reference frame, and a difference between the reference template and the current template can be calculated based on an optimization measurement. The process can be iterated for different reference templates within a search area of the reference frame, and the refinement MV is found to minimize the difference between the reference template and the current template according to the optimization measurement. In some embodiments, when the MV candidate is a CPMV candidate for a video coding system operating under the affine motion model in an affine inter mode or an affine merge mode, the refinement MV can be a refinement CPMV.

When the MV candidate is a CPMV, the TM process can be applied to derive the refinement CPMV. In deriving the refinement CPMV, the reference template can be generated based on an affine MV field comprising MVs of various sub-blocks or pixels of the sub-blocks. Accordingly, the refinement CPMV is derived based on the reference template generated based on an affine MV field, which is different from the reference template generated for other motion models such as the translational motion model.

In some embodiments, when one or more additional hypothesis predictions hₙ₊₁ are used to generate the prediction signal according to the linear iterative formula Pᵢ=(1−αᵢ) Pᵢ₋₁+αᵢ hᵢ, Pₙ₊₁=(1−αₙ₊₁) Pₙ+αₙ₊₁ hₙ₊₁, the one or more additional hypothesis predictors hₙ₊₁ can be replaced by predictors obtained by MC performed using TM refinement of an additional hypothesis motion vector used for obtaining a predictor hₙ₊₁=MC(MV(hₙ₊₁)), denoted as h′ₙ₊₁=MC(TM(MV(hₙ₊₁))), where h′ₙ₊₁ is predictor obtained by MC performed using MV derived based on a template matching (TM) process applied to the motion vector used to obtain prediction hₙ₊₁, MV(hₙ₊₁), and the prediction signal can be obtained using the same formula using the refinement h′ₙ₊₁ in place of hₙ₊₁, e.g., Pₙ₊₁=(1−αₙ₊₁) Pₙ+αₙ₊₁ h′ₙ₊₁.

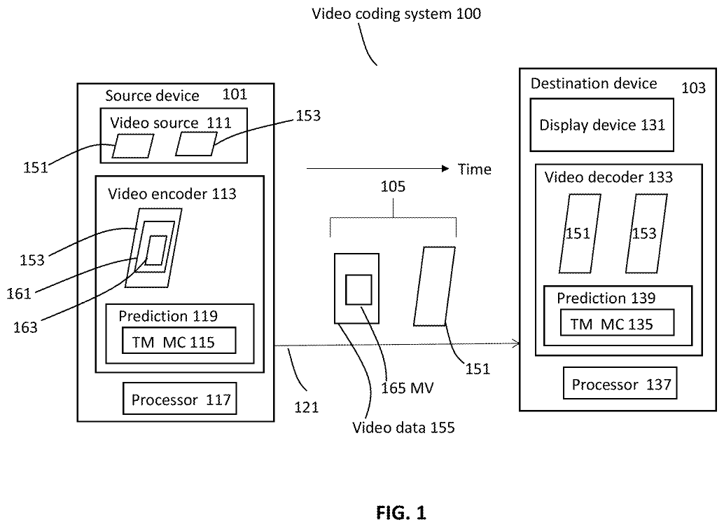

FIGS. 1-3 illustrate an example video coding system 100 for performing template matching on a search area of a reference frame to find a refinement of an initial MV for motion compensation, according to some aspects of the disclosure. As shown in FIG. 1, video coding system 100 can include a video encoder 113 within a source device 101 and a video decoder 133 within a destination device 103 coupled to source device 101 by a communication channel 121. Source device 101 may also be referred to as a video transmitter or a transmitter or a sender, while destination device 103 may also be referred to as a video receiver or other similar terms known to a person having ordinary skill in the art(s).

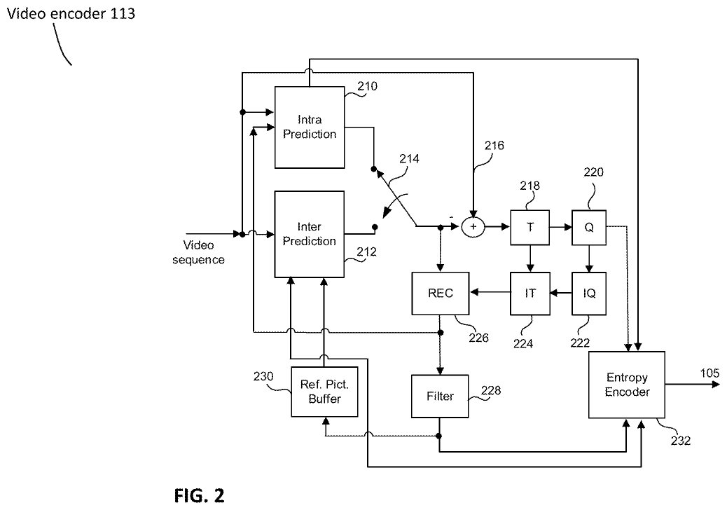

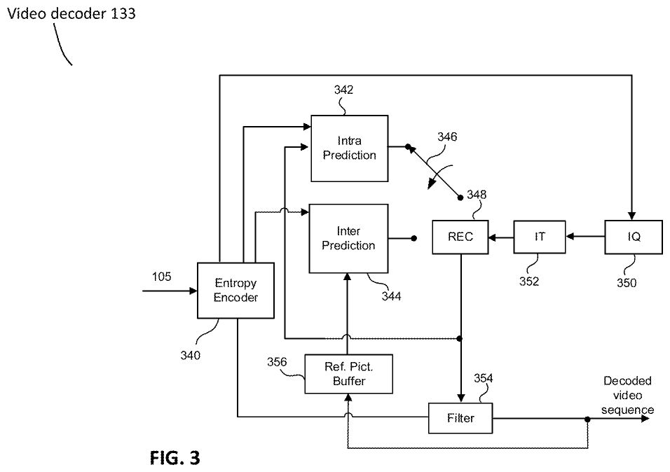

Some embodiments of video encoder 113 are shown in FIG. 2, and some embodiments of video decoder 133 are shown in FIG. 3. Video coding system 100 can include other components, such as pre-processing, post-processing components, which are not shown in FIG. 1. In some embodiments, source device 101 and destination device 103 may operate in a substantially symmetrical manner such that, each of source device 101 and destination device 103 includes video encoding and decoding components. Hence, video coding system 100 may support one-way or two-way video transmission between source device 101 and destination device 103, e.g., for video streaming, video playback, video broadcasting, or video telephony.

In some embodiments, communication channel 121 may include any wireless or wired communication medium, such as a radio frequency (RF) spectrum or one or more physical transmission lines, or any combination of wireless and wired media. Communication channel 121 may form part of a packet-based network, such as a local area network (LAN), a wide-area network (WAN), or a global network, such as the Internet, comprising an interconnection of one or more networks. Communication channel 121 can generally represent any suitable communication medium, or collection of different communication media, for transmitting video data from source device 101 to destination device 103. Communication channel 121 may include routers, switches, base stations, or any other equipment that may be useful to facilitate communication from source device 101 to destination device 103. In some other embodiments, source device 101 may store the video data in any type of storage medium. Destination device 103 may receive the video data through any type of storage medium, which should not be limited in this disclosure.

In some embodiment, source device 101 and destination device 103 can include a communication device, such as a cellular phone (e.g., a smart phone), a personal digital assistant (PDA), a handheld device, a laptop, a desktop, a cordless phone, a wireless local loop station, a wireless sensor, a tablet, a camera, a video surveillance camera, a gaming device, a netbook, an ultrabook, a medical device or equipment, a biometric sensor or device, a wearable device (smart watch, smart clothing, smart glasses, smart wrist band, smart jewelry such as smart ring or smart bracelet), an entertainment device (e.g., a music or video device, or a satellite radio), a vehicular component, a smart meter, an industrial manufacturing equipment, a global positioning system device, an Internet-of-Things (IoT) device, a machine-type communication (MTC) device, an evolved or enhanced machine-type communication (eMTC) device, or any other suitable device that is configured to communicate via a wireless or wired medium. For example, a MTC and eMTC device can include, a robot, a drone, a location tag, and/or the like.

In some embodiment, source device 101 can include a video source 111, video encoder 113, and one or more processor 117 or other devices. Video source 111 of source device 101 may include a video capture device, such as a video camera, a video archive containing previously captured video, or a video feed from a video content provider. In some embodiments, video source 111 may generate computer graphics-based data as the source video, or a combination of live video, archived video, and computer-generated video. Accordingly, video source 111 can generate a video sequence including one or more frames, such as a frame 151 which can be a reference frame, and a frame 153 which can be a current frame. A frame may be referred to as a picture in the current description.

In some embodiments, destination device 103 can include video decoder 133, a display device 131, and one or more processor 137 or other devices. Video decoder 133 may reconstruct frame 151 or frame 153 and display such frames at display device 131. In some embodiments, display device 131 may include any of a variety of display devices such as a cathode ray tube, a liquid crystal display (LCD), a plasma display, an organic light emitting diode (OLED) display, or another type of display device.

Video encoder 113 and video decoder 133 may be designed according to some video coding standards such as MPEG-4, Advanced Video Coding (AVC), high efficiency video coding (HEVC), versatile video coding (VVC) standard, or other video coding standards. The techniques described herein are not limited to any particular coding standard. Video encoder 113 and video decoder 133 may be implemented as one or more microprocessors, digital signal processors (DSPs), application specific integrated circuits (ASICs), field programmable gate arrays (FPGAs), discrete logic, software, hardware, firmware or any combinations thereof. Video encoder 113 and video decoder 133 may be included in one or more encoders or decoders, or integrated as part of a combined encoder/decoder (CODEC) in a respective mobile device, subscriber device, broadcast device, server, or the like.

In some embodiments, video encoder 113 can be responsible for transforming the video sequence from video source 111 to a compressed bit stream representation, e.g., video stream 105, which is suitable for transmission or storage. For example, video stream 105 can be generated from the video sequence including frame 151 and frame 153, transmitted from video encoder 113 to video decoder 133 through communication channel 121.

In some embodiments, video encoder 113 can perform various operations that can be divided into a few sub-processes: prediction, transform, quantization and entropy encoding, each responsible for compressing the video sequence captured by video source 111 and encoding it into a bit stream such as video stream 105. Prediction operations can be performed by a prediction component 119, which finds redundant information within the current picture or frame (intra-prediction) or adjacent pictures or frames in the video sequence (inter-prediction) and compresses the information into a prediction signal included in video stream 105. The parts of a frame that cannot be compressed using prediction forms the residual signal which is also included in video stream 105. Video encoder 113 can further include other parts such as a transform component, a quantization, and an entropy coding component, with more details shown in FIG. 2.

Prediction component 119 can include a template matching (TM) based refinement of a motion vector (MV) used to perform motion compensation (MC) component 115. Based on prediction component 119, without transmitting the current frame 153, only reference frame 151 and the inter-frames difference between frame 151 and frame 153 may be transmitted in video stream 105 to improve the communication efficiency between source device 101 and destination device 103. In some embodiments, video stream 105 can include a plurality of frames, such as frame 151 that is the reference frame. Video stream 105 can further include video data 155 generated by TM MC component 115, which may include a MV 165, to be used to reconstruct frame 153 by video decoder 133 based on reference frame 151 and video data 155. As shown in FIG. 1, frame 151 is transmitted before information for frame 153, such as video data 155, which includes MV 165, are transmitted.

Video decoder 133 can perform the inverse functions of video encoder 131 to reconstruct the video sequence from the compressed video stream 105. The decoding process can include entropy decode, de-quantization, inverse transform, and prediction operations, with more details shown in FIG. 3. The prediction operations can be performed by a prediction component 139, which can include a TM MC component 135. The parts of the video sequence including frame 151 and frame 153 that has been compressed using either intra- or inter-prediction methods can be reconstructed by combining the prediction and residual signals received in video stream 105. For example, video decoder 133 can use TM MC component 135 and prediction component 139 to reconstruct frame 153 based on reference frame 151 and video data 155 including MV 165 transmitted by video stream 105.

Video encoder 113 and video decoder 133 may perform encoding or decoding on a sub-block or block basis, where a picture or frame of the video sequence can be split up into non-overlapping coding blocks to be encoded or decoded. A coding block can be simply referred to as a block. In detail, a frame, such as frame 153 in FIG. 1, can include multiple blocks such as a block 161. A block, such as block 161, can include multiple sub-blocks, such as sub-block 163. A block can be implemented in various ways. A block can be a coding tree unit (CTU), a macroblock (e.g., 16×16 samples), or other block. The CTU can vary in size (e.g., 16×16, 32×32, 64×64, 128×128 or 256×256). A CTU block can be divided into blocks of different types and sizes. The size of each block is determined by the picture information within the CTU. Blocks that contain many small details are typically divided into smaller sub-blocks to retain the fine details, while the sub-blocks can be larger in locations where there are fewer details, e.g. a white wall or a blue sky. The relation between blocks and sub-blocks can be represented by a quadtree data structure, where the CTU is the root of the coding units (CU). Each CU contains three blocks for each color component, i.e. one block for luminosity (Y), chromatic blue (Cb or U) and chromatic red (Cr or V). The location of the luminosity blocks are used to derive the location of the corresponding chroma blocks, with some potential deviation for the chroma components depending on the chroma subsampling setting. As an example, the ITU-T H.264 standard supports intra prediction in various block sizes, such as 16 by 16, 8 by 8, or 4 by 4 for luma components, and 8×8 for chroma components, as well as inter prediction in various block sizes, such as 16 by 16, 16 by 8, 8 by 16, 8 by 8, 8 by 4, 4 by 8 and 4 by 4 for luma components and corresponding scaled sizes for chroma components. The blocks may have fixed or varying sizes, and may differ in size according to a specified coding standard.

A CTU may contain one CU or recursively split into four smaller CUs according to a quad-tree partitioning structure at most until a predefined minimum CU size is reached. The prediction decision can be made by prediction component 119 in FIG. 1 of video encoder 113 or prediction component 139 of video decoder 133 at the CU level, where each CU is coded using either inter picture prediction or intra picture prediction. Once the splitting of CU hierarchical tree is done, each CU is subject to further split into one or more Prediction Units (PUs) according to a PU partition type for prediction. The PU works as a basic representative block for sharing prediction information as the same prediction process is applied to all pixels in the PU. The prediction information is conveyed from video encoder 113 to video decoder 133 on a PU basis. In some embodiments, a different process involving the CTU, CU, PU may be applied using any of the current video coding standards.

In some embodiments, motion estimation in inter frame prediction identifies one (uni-prediction) or two (bi-prediction) best reference blocks for a current block in one or two reference frames, and motion compensation in inter frame prediction locates the one or two best reference blocks according to one or two motion vectors (MVs). A difference between the current block and a corresponding predictor is called prediction residual. Video encoder 113 or video decoder 133 may include a sub-block partitioning module or a MV derivation module, not shown.

In some embodiments, a MV can be generated based on various motion models, such as a translational motion model, a 4-parameter affine motion model for translation, zoom, or rotation in an image plane, a 6-parameter affine motion model, which are all known to a person having ordinary skill in the art(s).

FIG. 2 illustrates an example system block diagram for video encoder 113. Intra Prediction 210 can provide intra predictors based on reconstructed video data of a current picture. Inter Prediction 212 performs motion estimation (ME) and motion compensation (MC) to provide inter predictors or prediction signals based on video data from other picture or pictures. Intra Prediction 210 may make predictions related to predicting the pixel values in a block of a picture relative to reference samples in neighboring, previously coded blocks of the same picture. In intra frame prediction, a sample is predicted from reconstructed pixels within the same frame for the purpose of reducing the residual error that is coded by the transform (e.g., Entropy Encoder 232) and entropy coding (e.g., Entropy Encoder 232) part of a predictive transform codec. The Inter Prediction 212 can determine a predictor or a prediction signal for each sub-block according to the corresponding sub-block MV. The predictor or prediction signal for each sub-block is limited to be within the primary reference block according to some embodiments. Selector 214 can select either Intra Prediction 210 or Inter Prediction 212 to supply the selected predictor to Adder 216 to form prediction errors, also called prediction residual. Either Intra Prediction 210 or Inter Prediction 212, or both can be included in prediction component 119 shown in FIG. 1.

The prediction residual of the current block is further processed by Transformation (T) 218 followed by Quantization (Q) 220. The transformed and quantized residual signal is then encoded by Entropy Encoder 232 to form video stream 105. Video stream 105 may further be packed with side information. The transformed and quantized residual signal of the current block may be processed by Inverse Quantization (IQ) 222 and Inverse Transformation (IT) 224 to recover the prediction residual. The prediction residual is recovered by adding back to the selected predictor at Reconstruction (REC) 226 to produce reconstructed video data. The reconstructed video data may be stored in Reference Picture Buffer 230 and used for prediction of other pictures. The reconstructed video data recovered from REC 226 may be subject to various impairments due to encoding processing; consequently, in-loop processing Filter 228 can be applied to the reconstructed video data before storing in the Reference Picture Buffer 230 to further enhance picture quality.

FIG. 3 illustrates an example system block diagram of corresponding video decoder 133 for decoding the video stream 105 received from video encoder 113. Video stream 105 is the input to video decoder 133 and is decoded by entropy decoder 340 to parse and recover the transformed and quantized residual signal and other system information. The decoding process of video decoder 133 is similar to the reconstruction loop at video encoder 113, except video decoder 133 only requires motion compensation prediction in Inter Prediction 344. Each block is decoded by either Intra Prediction 342 or Inter Prediction 344. Switch 346 selects an intra predictor from Intra Prediction 342 or an inter predictor from Inter Prediction 344 according to decoded mode information. Either Intra Prediction 342 or Inter Prediction 344, or both, can be included in prediction component 139 shown in FIG. 1. Inter Prediction 344 performs a sub-block motion compensation coding tool on a current block based on sub-block MVs. The transformed and quantized residual signal associated with each block is recovered by Inverse Quantization (IQ) 350 and Inverse Transformation (IT) 352. The recovered residual signal is reconstructed by adding back the predictor in REC 348 to produce reconstructed video. The reconstructed video is further processed by in-loop processing Filter (Filter) 354 to generate final decoded video. If the currently decoded picture is a reference picture for later pictures in decoding order, the reconstructed video of the currently decoded picture is also stored in reference picture Buffer 356.

In some embodiments, adaptive motion vector resolution (AMVR) can support various kinds of motion vector resolutions, including quarter-luma samples, integer-luma samples, and four-luma samples, to reduce side information of Motion Vector Differences (MVDs). For example, the supported luma MV resolutions for translational mode may include: quarter-sample, half-sample, integer-sample, 4-sample; and the supported luma MV resolutions for affine mode may include: quarter-sample, 1/16-sample, integer-sample. Flags signaled in Sequence Parameter Set (SPS) level and CU level are used to indicate whether AMVR is enabled or not and which motion vector resolution is selected for a current CU. For a block coded in Advanced Motion Vector Prediction (AMVP) mode, one or two motion vectors are generated by uni-prediction or bi-prediction, and then one or a set of Motion Vector Predictors (MVPs) are also generated at the same time. A best MVP with the smallest Motion Vector Difference (MVD) compared to the corresponding MV is chosen for efficient coding. With AMVR enabled, MVs and MVPs are both adjusted according to the selected motion vector resolution, and MVDs will be aligned to the same resolution.

In some embodiments, MV 165 in FIG. 1 can be specified based on a motion model, which can include a translational motion model, an affine motion model, or some other motion model. In the translational motion model, one MV included in a uni-prediction signal, such as MV 165, may be enough to specify the difference between a sub-block of a current frame and a sub-block of a reference frame caused by some rigid movements in a linear fashion. In some embodiments, two MVs with respect to two reference frames included in a bi-prediction signal may be used as well.

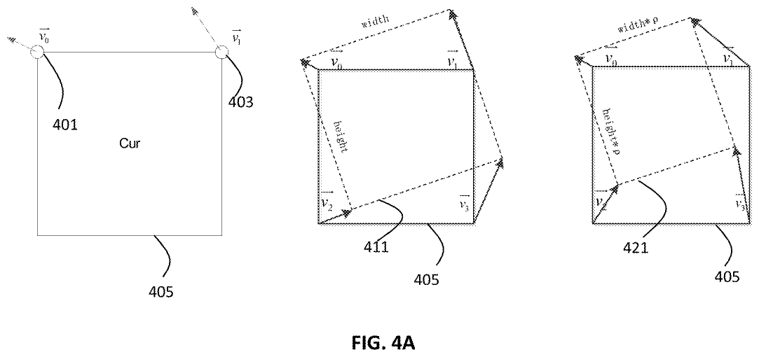

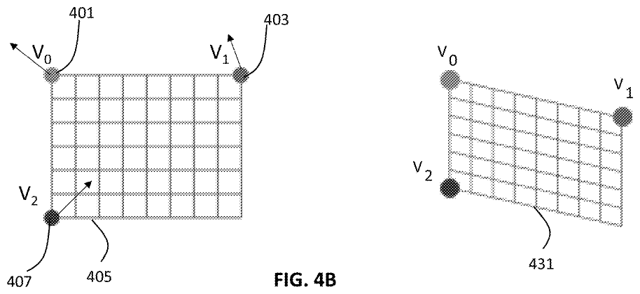

Objects in video source 111 may not always move in a linear fashion and often rotate, scale, and combine different types of motion. Some of those movements can be presented with affine transformations. Affine transformation is a geometric transformation that preserves the lines and parallelism in the video. These movements include zoom in/out, rotation, perspective motion, and other irregular motion. Affine prediction may be based on the affine motion model, and thus extend the conventional MV in the translational motion model to provide more degrees of freedom. An affine motion model may include a block-based 4-parameter and 6-parameter affine motion model, where 2 or 3 MVs can be used to specify various movements such as rotation or zooming for the current frame with respect to one reference frame. In some embodiments, in an affine motion model, MV 165 can be a control point motion vector (CPMV), where a CPMV is a MV at various control points of a sub-block or a block, as shown in FIGS. 4A-4B.

FIGS. 4A-4B illustrate example CPMVs for a sub-block 405 in a frame of a video stream according to an affine mode, according to some aspects of the disclosure. In some embodiments, sub-block 405 in a frame of a video stream can be an example of sub-block 163 in frame 153 of video stream 105.

FIG. 4A shows two CPMVs, V₀ at control point 401, and V₁ at control point 403, which are MVs located at control points for a 4-parameter affine motion model. An affine transformation based on the two CPMVs V₀ and V₁ can be expressed below. Two CPMVs V₀ and V₁ can represent a sub-block 411 obtained from sub-block 405 by rotation, or a sub-block 421 obtained from sub-block 405 by rotation in addition to scaling.

$$\{ \begin{matrix}{v}_{x} = \frac{( {v}_{1 x} - {v}_{0 x} )}{w} x - \frac{( {v}_{1 y} - {v}_{0 y} )}{w} y + {v}_{0 x} \\ {v}_{y} = \frac{( {v}_{1 y} - {v}_{0 y} )}{w} x + \frac{( {v}_{1 x} - {v}_{0 x} )}{w} y + {v}_{0 y}\end{matrix}$$

FIG. 4B shows three CPMVs, V₀ at control point 401, V₁ at control point 403, and V₂ at control point 407, which are MVs located at control points for a 6-parameter affine motion model. An affine transformation based on the three CPMVs V₀, V₁, and V₂ can be expressed in the formula below. Three CPMVs V₀, V₁, and V₂ can represent a sub-block 431 obtained from sub-block 405 by a general affine transformation.

$$\{ \begin{matrix}{v}_{x} = \frac{( {v}_{1 x} - {v}_{0 x} )}{w} x + \frac{( {v}_{2 x} - {v}_{0 x} )}{h} y + {v}_{0 x} \\ {v}_{y} = \frac{( {v}_{1 y} - {v}_{0 y} )}{w} x + \frac{( {v}_{2 y} - {v}_{0 y} )}{h} y + {v}_{0 y}\end{matrix}$$

Under the affine motion model where a MV can refer to a CPMV, the video coding system may operate in various operation modes such as an affine inter mode, an affine merge mode, an advanced motion vector prediction (AMVP) mode, or some other affine modes. An operation mode, such as an affine inter mode or an affine merge mode, may specify how a CPMV or a CPMV candidate is generated or transmitted. When the video coding system operates in the affine inter mode, the CPMVs or CPMV candidates of a sub-block can be generated and signaled from the source device to the destination device directly. In some embodiments, the video coding system may operate in an affine merge mode, where CPMVs or CPMV candidates of a sub-block are not generated by the source device and signaled from the source device to a destination device directly, but rather generated from motion information of spatial and temporal neighbor blocks of the sub-block by the video decoder of the destination device of the video coding system.

In some embodiments, when a CPMV candidate is generated or transmitted from the source device in affine inter mode, the destination device can receive the CPMV candidate and perform refinement on the CPMV candidate. In some embodiments, when the coding system operates in the affine merge mode, the destination device can generate CPMV candidate from motion information of spatial or temporal neighbor blocks of the sub-block. Furthermore, the video decoder of the destination device can perform refinement on the CPMV candidate. In the 4-parameter affine motion model, there can be 2 CPMV candidates, while in the 6-parameter affine motion model, there can be 3 CPMV candidates. The video decoder of the destination device can perform refinement for each CPMV candidate of the 2 CPMV candidates for the 4-parameter affine motion model or 3 CPMV candidates for the 6-parameter affine motion model.

Template matching (TM) previously proposed in JVET-J0021 is a decoder MV derivation method to refine the motion information of the current CU by finding the closest match between a template (i.e., top and/or left neighbouring blocks of the current CU) in the current picture and a block in a reference picture. However, in the previous work, TM has not been applied to CPMV candidates of the 4-parameter affine motion model or the 6-parameter affine motion model. Embodiments herein present techniques in applying TM process to CPMV candidates of the 4-parameter affine motion model or the 6-parameter affine motion model.

In an embodiment of TM-based Affine CPMV Refinement of the present application, it is suggested in affine mode to use TM when performing CPMV refinement. As a result, no need to transfer CPMV MVD. Since there are more MVDs in affine mode, this can be more beneficial. In one embodiment, in affine merge TM is used to refine CPMV and make MV predictor better/more precise.

In one embodiment, in case of affine-inter TM is used to do CPMV refinement, which allows to avoid transferring MVD.

In one embodiment, in case of affine-MMVD, affine-merge and TM are combined together to find the refined CPMV.

In one embodiment, in order to make the prediction even better, additional MMVD-like fixed adjustment can be additionally signaled.

In one embodiment, the flow to do the L-template search for CPMV is following: for each CPMV candidate->generate affine MV field □ retrieve the L-shape template of neighboring pixels for the reference sub-PU for affine MV field □ calculate the L-shape of neighboring pixels from the reference pixels and the current L-shape of neighboring pixels for SAD or SSD. We can repeat the previous search process for various CPMV candidates. Note that, because CPMV may have either 2 MVs (4-parameter affine model) or 3 MVs (6-parameter affine model), so we can search 2 MVs or 3 MVs one-by-one. In another embodiment, we can send partial CPMV and apply refinement to another CPMV, for example, in 3 MV affine mode, we can send 2 MV, and the remaining 1 MV can be derived at decoder side.

Another CPMV refinement method can be used for bi-directional affine mode. In one embodiment, we can compare list 0 affine predictor with list 1 affine predictor, and, when adjusting the CPMV, we can compare again the list 0 predictor and list 1 predictor until we find the minimum difference.

Since there has to be a lot of search performed for TM and a large region of the reference picture must be loaded for performing TM, one embodiment of the current invention TM is combined with multi-hypothesis prediction. This allows to improve the coding performance and reduce the error of ME search at the decoder. That is, not only the best result in TM process is used, but also the best N results are utilized to generate the final prediction, where N is greater than 1. In another embodiment, the best result in TM process is further combined with the predictor generated by the initial MV.

In one embodiment, it is proposed to apply bi-lateral filtering or pre-defined weights when performing blending between multiple predictors.

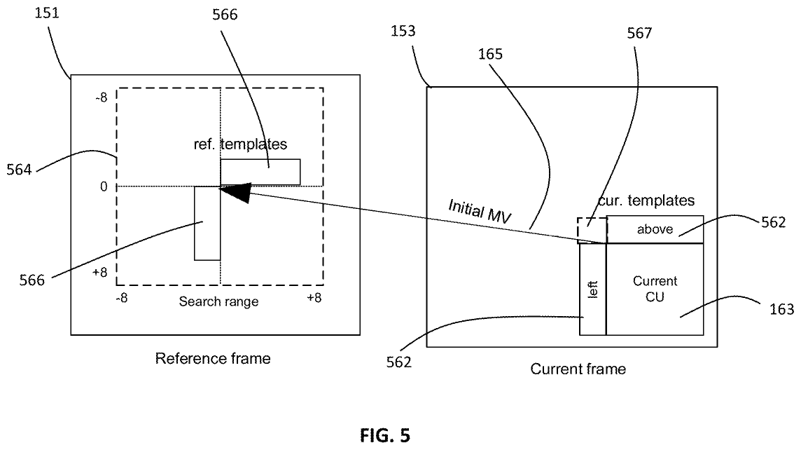

FIG. 5 illustrates an example of template matching performed on a search area 564 of reference frame 151 to find a refinement of motion vector 165, which may be an initial MV or a MV candidate, for motion compensation for sub-block 163, according to some aspects of the disclosure.

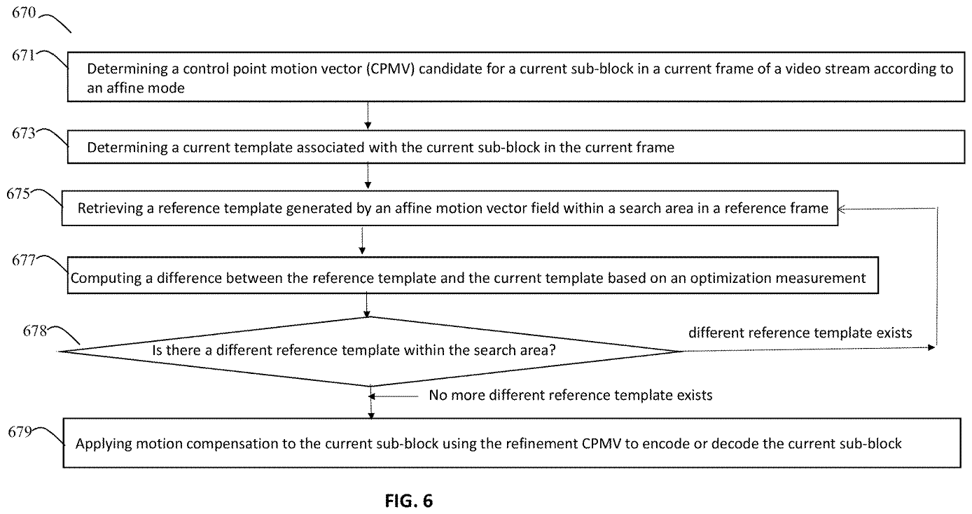

In some embodiments, MV 165 can be a control point motion vector (CPMV) candidate for sub-block 163, which can be a current sub-block of a current block in the current frame 153 of video stream 105 according to an affine mode, e.g., an affine inter mode or an affine merge mode. A template matching (TM) based MC process, such as a process 670 shown in FIG. 6, can be performed by TM MC 115 or TM MC 135 on one or more CPMV candidates. Descriptions for TM MC 115 (from FIG. 1) can be applicable to TM MC 135 (from FIG. 1). In some embodiments, following a refinement approach, a refinement of the CPMV candidate can be found by a TM process based on a current template of the current sub-block in the current frame and a reference template in the reference frame, where the reference template may be generated by an affine motion vector field.

In some embodiments, there may be two ways to generate the reference template. First, after computing CPMVs, the affine motion vector field (e.g., motion vectors for each 4×4 sub-block) can be computed. Using MVs of each 4×4 sub-block, reference sub-blocks can be computed, and the reference template can be constructed from the templates obtained for each top and left 4×4 sub-block. In some embodiments, because the template is constructed from samples above and/or left of the block, only those sub-blocks that are at the top and/or left border of the block may be needed to construct the reference template. Second, after computing the CPMVs, one MV for the whole block can be computed, e.g., the MV in the center of this block. Furthermore, one reference block can be computed using the one MV. Moreover, using samples above and/or left of the one reference block, the reference template can be constructed.

In some embodiments, there can be two refinement approaches, which can also be combined with the above two methods for constructing the reference template. First, the 2 or 3 (depending on the affine model) CPMVs can be refined at the same time and/or with the same value. Accordingly, all CPMVs can be updated at the same time. Based on the updated CPMVs, new MVs for each 4×4 sub-block (or a new MV for the center position of the block) can be computed to obtain the corresponding reference template. By updating all the CPMVs with the same value, different reference templates can still be obtained. The update that provides the best fit between the current template and the reference template in terms of the optimization measurement can be selected as the refinement. Second, the CPMVs can be updated independent from each other. For example, the first CPMV can be updated. Afterwards, based on the updated first CPMV and non-updated second (and if available-third CPMV), re-compute the MVs for each 4×4 sub-block (or re-compute MV for the center position of the block) to obtain the corresponding reference template. The offset that is an update of the first CPMV to provide the best fit between the current template and the reference template in terms of the optimization measurement would be the refinement of the first CPMV. For the second CPMV refinement, the non-updated first CPMV or the updated first CPMV may be used to obtain the refinement of the second CPMV. For the third CPMV, if it is available, the refinement of the third CPMV can be obtained similarly as the refinement of the second CPMV. In one embodiment, the TM-based refinement is applied to the MV of the block (e.g. MV of the center position of the block) and then updated CPMVs and/or sub-block MVs are obtained based on this refined motion vector.

In some embodiments, in case of affine mode, for a TM-based refinement, the CPMVs may be adjusted to obtain the corresponding reference template. The CPMVs are defined for the coding blocks, which are coded with affine mode (affine AMVP or affine Merge mode). Based on the 2 or 3 CPMVs, for each 4×4 sub-block of the coding block, separate motion vector (e.g., at position (2, 2) of each 4×4 sub-block) can be defined based on the formulas for 4 or 6-parameter affine motion model. The CPMV can be updated in different ways. In some embodiments, the same offset to the CPMVs can be added to change the values of v₀ₓ, v₁ₓ and v_{0y}, v_{1y} of the two CPMVs V₀ and V₁ shown in paragraph [0048]. In some other embodiments, 6 parameter affine model can be used as it is described in paragraph [0049], and then all or a subset of the three CPMVs would be updated (v₀ₓ, v₁ₓ, v₂ₓ and v_{0y}, v_{1y}, v_{2y}) . . . . In some embodiments, only the values of v₀ₓ and v_{0y} are updated (meaning only base MV representing translation motion of the affine model is updated). In some other embodiments, one/subset or all of the parameters,

$$\frac{( {v}_{1 x} - {v}_{0 x} )}{w} , \frac{( {v}_{2 x} - {v}_{0 x} )}{h} and \frac{( {v}_{1 y} - {v}_{0 y} )}{w} , \frac{( {v}_{2 y} - {v}_{0 y} )}{h}$$

can be updated. In some embodiments, the search range, such as [−1 to 1] or [−2 to 3] can be defined with various step sizes for adjusting each of the coefficients. In addition, different adjustment may be performed based on the new adjusted coefficients to compute new MVs, which may be MVs for each 4×4 sub-block or for one position (e.g. middle position of the block). Based on the updated MVs, the corresponding reference template can be obtained, and the difference between the current template and reference template can be computed.

In some embodiments, when one or more additional hypothesis motion vectors are used to generate the additional hypothesis prediction signal hₙ₊₁ utilized for obtaining a prediction Pₙ₊₁ according to a linear iterative formula Pᵢ=(1−αᵢ) Pᵢ₋₁+αᵢ hᵢ, Pₙ₊₁=(1−αₙ₊₁) Pₙ+αₙ₊₁ hₙ₊₁, the one or more additional hypothesis prediction hₙ₊₁ can be replaced by a refined hypothesis prediction h′ₙ₊₁=MC(TM(MV((hₙ₊₁))), where h′ₙ₊₁ is a refined hypothesis obtained based on a motion compensation (MC) performed using a refinement by template matching (TM) process applied to the motion vector used to obtain prediction hₙ₊₁, and the prediction signal can be obtained using the same formula using the refinement h′ₙ₊₁=MC(TM(MV((hₙ₊₁))) in place of hₙ₊₁.

FIG. 6 shows a template matching based MC process 670, which can be performed by TM MC 115 or TM MC 135.

In some embodiments, at operation 671, TM MC 115 can determine a CPMV candidate, which can be MV 165, for the current sub-block 163 in the current frame 153 of video stream 105 according to an affine mode. At operation 673, TM MC 115 can determine a current template 562 associated with the current sub-block 163 in the current frame 153. At operation 675, TM MC 115 can retrieve a reference template 566 generated by an affine motion vector field within search area 564 in reference frame 151. However, it is contemplated that the reference template 566 can be determined in other ways. At operation 677, TM MC 115 can further compute a difference between the reference template 566 and the current template 562 based on an optimization measurement (e.g., SAD or SSD). At operation 678, TM MC 115 can determine whether there is a different reference template within the search area 564 whose difference with the current template 562 has been calculated or not. If TM MC 115 determines there is a different reference template within the search area 564 whose difference with the current template 562 has not been calculated, TM MC 115 can loop back to operation 675 and operation 677, iterates the retrieving the different reference template operation, and computing the difference between the different reference template within the search area 564 and the current template 562 operation. The current template 562 is fixed with respect to all the reference templates. Hence, TM MC 115 can iterate within the search area 564 to go through all reference templates within the search area 564, and compute the difference between the different reference template and the fixed current template 562.

Further, at operation 678, when there are no more different reference templates can be found, a refinement CPMV is found by selecting a MV between the current sub-block 163 and a reference template that minimizes the difference according to the optimization measurement. Afterwards, at 679, TM MC 115 can apply motion compensation to the current sub-block 163 using the refinement CPMV to encode or decode the current sub-block 163.

In some embodiments, current template 562 associated with the current sub-block 163 or reference template 566 can include an L-shaped template including neighboring pixels above and at a left side of the current sub-block 163, as shown in FIG. 5. Similarly, reference template 566 can include an L-shaped template including neighboring pixels above and at a left side. However, other shapes for template 562 can be used as well as would be apparent to a person of ordinary skill in the art(s). For example, current template 562 can include pixels 567 at the corner of sub-block 163 that is adjacent to both the above side and the left side of the current template 562. In this case, the reference template would need to be modified in the same way.

In some embodiments, the optimization measurement can include a sum of absolute differences (SAD) measurement or a sum of squared differences (SSD) measurement. In some embodiments, the search area 564 in the reference frame 151 can include a [−8, +8]-pel range of the reference frame 151. However, search areas having a different size can be used as well as would be apparent to a person of ordinary skill in the art(s).

In some embodiments, MV 165 can be a first CPMV candidate for sub-block 163, which can be a current sub-block of a current block in a current frame 153 of video stream 105. In addition, video stream 105 can further include a second CPMV candidate of the current sub-block 163 according to the affine mode, e.g., a 4-parameter affine model or additionally a third CPMV candidate for a 6-parameter affine model. For the second and/or third CPMV candidates, TM-based refinement of each CPMV candidate can be performed independently. Additionally and alternatively, a TM-based refinement of each of the next CPMV candidate can be performed considering results of the refinement process applied to the previous CPMV(s). In another embodiment, all two (or three, in case of a 6-parameter affine model) CPMV candidates can be refined together. The refinement can be applied either directly to the CPMVs or to one MV(e.g. MV of the center position of the block) and then updated CPMVs and/or sub-block MVs are obtained based on this refined motion vector. TM MC 115 can retrieve a second reference template generated by the affine motion vector field within the search area 564 in the reference frame 151, and compute a difference between the second reference template and the current template 562 based on the optimization measurement. In addition, TM MC 115 can iteratively perform, as shown in FIG. 6, the retrieving and the computing operations for a different reference template within the search area 164 until a second refinement CPMV is found to minimize the difference according to the optimization measurement. TM MC 115 can further apply motion compensation to the current sub-block 163 using the second refinement CPMV to encode or decode the current sub-block 163. The first refinement CPMV or the second refinement CPMV can be a CPMV of the current sub-block based on a 4-parameter affine model or a 6-parameter affine model.

In some embodiments, TM MC 115 can perform motion compensation based on the CPMV for the current sub-block without a motion vector difference (MVD) being transferred from the video encoder 113. In some cases, the current sub-block 163 can be coded based on a 6-parameter affine model. In this case, TM MC 115 can receive additional side information from the video encoder 113 for motion compensation by the video decoder 133.

In some embodiments, when in affine mode, TM MC 115 or TM MC 135 can apply TM for performing CPMV refinement to improve the MV precision/accuracy. In an affine-inter mode, TM MC 115 can use TM to derive CPMV refinement and reduce magnitude of the signaled MVD. In another embodiment, some refinement CPMV can be sent for a subset of CPMVs and TM-based refinement can be applied to refine the remaining CPMV candidates. In some embodiments, for 6 parameter affine mode, 2 MVDs can be sent to define the CPMV, and TM MC 135 can refine 1 CPMV candidate using TM at the decoder side. In some embodiments, the order/number of the to-be-refined CPMV is predefined, in another embodiment, the number/order of the to-be-refined CPMV is explicitly or implicitly defined at the encoder and/or decoder. For the affine merge mode, TM MC 135 can use TM to refine CPMV candidates (similar to affine MMVD but no need to code MVD). In another embodiment, additional side information (e.g., MMVD-like fixed adjustment) can be signaled to improve results further.

In some embodiments, the flow to perform the L-template search for the refinement of CPMV candidate described above can be summarized as follows: for a CPMV candidate, TM MC 135 can generate an affine MV field. Based on the affine MV field, TM MC 135 can retrieve L-shape reference template for the reference sub-blocks, e.g., sub-PUs, generated by the affine MV field. Afterwards, TM MC 135 can compute a difference between the L-shape reference template from the reference frame 153 and the L-shape current template 162 of the current sub-block 163 (e.g., using an optimization measurement SAD or SSD). TM MC 135 can perform TM-based refinement process within the search area 564 in the reference frame 151 until the best result reference template is found, where the best result reference template can provide the smallest SAD or SSD between the current L-shaped template. Furthermore, TM MC 135 can apply the above algorithm for multiple (2 or 3 in case of affine) CPMV candidates one by one. As started earlier, the refinement can be performed either for all CPMVs together, or independently, or with consideration of the previously refined CPMV in sequence, or obtained for each of the CPMVs from one MV(e.g. MV of the center position of the block).

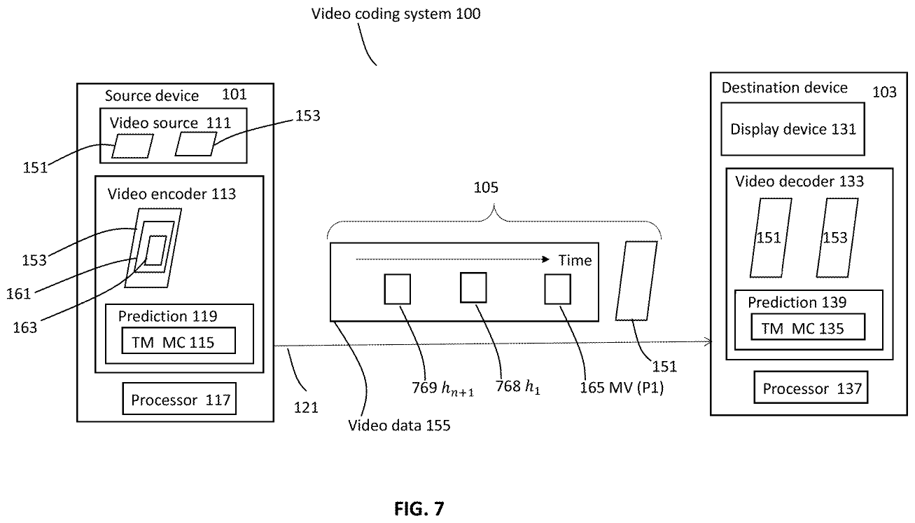

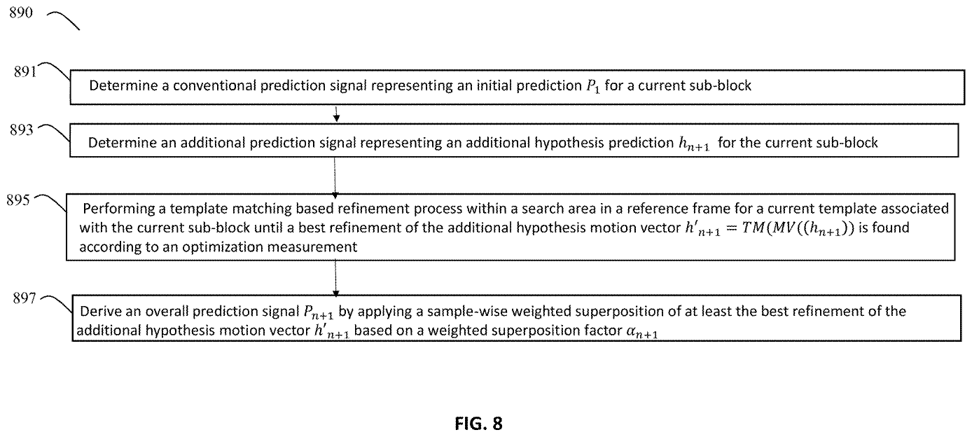

FIGS. 7 and 8 show a template matching based MC process 890 performed on motion vector used for obtaining a multiple hypothesis prediction h′ₙ₊₁ (MHP), which can be performed by TM MC 135 of video decoder 133. In MHP, one or more additional predictions can be signaled, in addition to the conventional uni-prediction represented by MV 165 or a bi-prediction signal. The resulting overall prediction signal is obtained by sample-wise weighted superposition based on the linear iterative formula Pᵢ=(1−αᵢ) Pᵢ₋₁+αᵢ hᵢ, Pₙ₊₁ (1−αₙ₊₁) Pₙ+αₙ₊₁ hₙ₊₁.

As shown in FIG. 7, video stream 105 can include MV 165, which can be used to obtain a traditional prediction signal P₁ obtained by AMVP or merge. In addition, video stream 105 can further include additional hypothesis prediction signal h₂ obtained by MV 768, and may include additional hypothesis prediction signal hₙ₊₁ obtained by MV 769. In some embodiments, there may be only one additional hypothesis prediction signal.

Assuming P is “traditional” prediction and h is additional hypothesis, the formula of multiple hypothesis prediction is as follows: Pₙ₊₁=(1−αₙ₊₁) Pₙ+αₙ₊₁ hₙ₊₁. For example, P₃=(1−α₃) P_{uni/bi}+α₃ h₃, where P_{uni/bi} is the conventional uni-prediction obtained by MV 165 or bi-prediction signal, and the first hypothesis, h₃, is the first additional inter prediction signal/hypothesis. In some embodiments, some possible choices for ai, where i=3, 4, . . . n+1, can be ¼, −⅛, or some other choices as would be apparent to a person having ordinary skill in the art(s).

FIG. 8 shows a template matching based MC process 890 performed using a motion vector used for obtaining a multiple hypothesis prediction h′ₙ₊₁ to reflect the calculations presented above. MC process 890 can be performed by TM MC 135, which can be implemented by one or more electronic devices or processors 137.

At operation 891, TM MC 135 can determine a conventional prediction signal representing an initial prediction P₁ for the current sub-block 163, where the prediction signal can be obtained by MV 165, which is shown as uni-prediction. When a bi-prediction signal is used, another MV can be available to represent P₂.

At operation 893, TM MC 135 can be performed to obtain prediction signal using the refined MV used to determine an additional prediction signal hₙ₊₁ for the current sub-block 163, where the additional hypothesis prediction hₙ₊₁ can be represented by MV(hₙ₊₁) 769.

At operation 895, TM MC 135 can perform a motion compensation using MV obtained by applying template matching based refinement process within the search area 564 in the reference frame 151 for the current template 562 associated with the current sub-block 163 until a refinement, or a best refinement, of the MV used to obtain additional hypothesis prediction h′ₙ₊₁=MC(TM(MV((hₙ₊₁))) is found according to an optimization measurement. In some embodiments, the optimization measurement can include a SAD measurement or a SSD measurement. Details of the template matching based refinement process are similar to the process 670 shown in FIGS. 4-6.

At operation 897, TM MC 135 can derive an overall prediction signal Pₙ₊₁ by applying a sample-wise weighted superposition of at least the prediction computed using MV obtained by applying TM refinement of the MV used for defining additional hypothesis prediction h′ₙ₊₁=MC(TM(MV(hₙ₊₁))) based on a weighted superposition factor αₙ₊₁. In some embodiments, the overall prediction signal Pₙ₊₁ can be derived based on a sample-wise weighted superposition formula Pₙ₊₁=(1−αₙ₊₁) Pₙ+αₙ₊₁ h′ₙ₊₁, where h′ₙ₊₁ is the prediction signal obtained by the TM-refined MV of the additional hypothesis prediction, based on the optimization measurement.

In some embodiments, to derive the overall prediction signal, TM MC 135 can be configured to derive the refined MV used for obtaining overall prediction signal further based on applying bi-lateral filtering or pre-defined weights.

In some embodiments, TM MC 135 can be configured to determining other additional prediction signal determined by other additional hypothesis motion vectors used for obtaining additional hypothesis predictions hᵢ for the current sub-block; performing the template matching based refinement process within the search area in the reference frame for the current template associated with the current sub-block until a best refinement of the other additional hypothesis motion vector TM(MV(hᵢ)) is found according to the optimization measurement; and derive an overall prediction signal Pₙ₊₁ by applying a sample-wise weighted superposition of at least the prediction signal determined by the best refinement TM(MV((hₙ₊₁)) of motion vector MV((hₙ₊₁)) used to compute the additional hypothesis prediction signal h′ₙ₊₁=MC(TM(MV((hₙ₊₁))) based on a weighted superposition factor αₙ₊₁, and the other prediction signal Pᵢ₋₁ obtained using motion vector TM(MV(hᵢ)).

In some embodiments, when TM refinement is applied, the MV with the minimum cost is chosen to be the final predictor of the current sub-block 163. To improve the coding efficiency, when generating the final prediction of MHP, TM MC 135 can use multiple prediction signals obtained with MVs from the TM refinement process having the best optimization results. In another embodiment, the final prediction of the MHP can be obtained by combining MC results defined using MVs obtained as the best result after the TM refinement process with the predictor generated by the initial MV. Bilateral filtering or pre-defined weights can be additionally used when performing blending between multiple predictors.

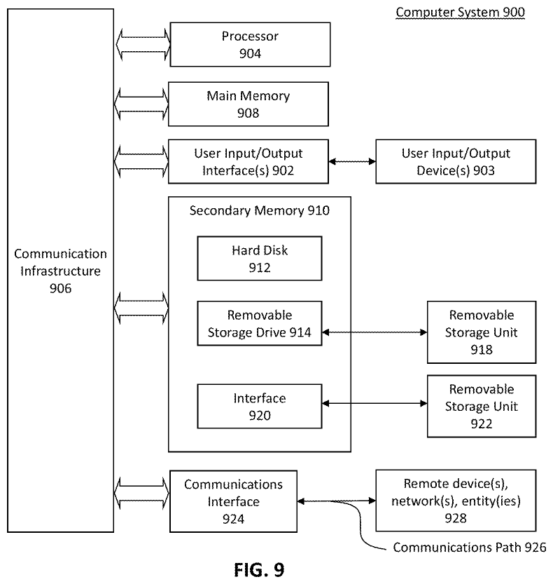

Various aspects can be implemented, for example, using one or more computer systems, such as computer system 900 shown in FIG. 9. Computer system 900 can be any computer capable of performing the functions described herein such as video encoder 113, source device 101, video decoder 133, and destination device 103 shown in FIGS. 1-3 and 7, for operations described in process 670 and 890 illustrated in FIGS. 6, 8. Computer system 900 includes one or more processors (also called central processing units, or CPUs), such as a processor 904. Processor 904 is connected to a communication infrastructure 906 (e.g., a bus). Computer system 900 also includes user input/output device(s) 903, such as monitors, keyboards, pointing devices, etc., that communicate with communication infrastructure 906 through user input/output interface(s) 902. Computer system 900 also includes a main or primary memory 908, such as random access memory (RAM). Main memory 908 may include one or more levels of cache. Main memory 908 has stored therein control logic (e.g., computer software) and/or data.

Computer system 900 may also include one or more secondary storage devices or memory 910. Secondary memory 910 may include, for example, a hard disk drive 912 and/or a removable storage device or drive 914. Removable storage drive 914 may be a floppy disk drive, a magnetic tape drive, a compact disk drive, an optical storage device, tape backup device, and/or any other storage device/drive.

Removable storage drive 914 may interact with a removable storage unit 918. Removable storage unit 918 includes a computer usable or readable storage device having stored thereon computer software (control logic) and/or data. Removable storage unit 918 may be a floppy disk, magnetic tape, compact disk, DVD, optical storage disk, and/any other computer data storage device. Removable storage drive 914 reads from and/or writes to removable storage unit 918 in a well-known manner.

According to some aspects, secondary memory 910 may include other means, instrumentalities or other approaches for allowing computer programs and/or other instructions and/or data to be accessed by computer system 900. Such means, instrumentalities or other approaches may include, for example, a removable storage unit 922 and an interface 920. Examples of the removable storage unit 922 and the interface 920 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

In some examples, main memory 908, the removable storage unit 918, the removable storage unit 922 can store instructions that, when executed by processor 904, cause processor 904 to perform operations for video encoder 113, source device 101, video decoder 133, and destination device 103 shown in FIGS. 1-3 and 7, for operations described in process 670 and 890 illustrated in FIGS. 6, 8.

Computer system 900 may further include a communication or network interface 924. Communication interface 924 enables computer system 900 to communicate and interact with any combination of remote devices, remote networks, remote entities, etc. (individually and collectively referenced by reference number 928). For example, communication interface 924 may allow computer system 900 to communicate with remote devices 928 over communications path 926, which may be wired and/or wireless, and which may include any combination of LANs, WANs, the Internet, etc. Control logic and/or data may be transmitted to and from computer system 900 via communication path 926. Operations of the communication interface 924 can be performed by a wireless controller, and/or a cellular controller. The cellular controller can be a separate controller to manage communications according to a different wireless communication technology. The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 900, main memory 908, secondary memory 910 and removable storage units 918 and 922, as well as tangible articles of manufacture embodying any combination of the foregoing. Such control logic, when executed by one or more data processing devices (such as computer system 900), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 9. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

For one or more embodiments or examples, at least one of the components set forth in one or more of the preceding figures may be configured to perform one or more operations, techniques, processes, and/or methods as set forth in the example section below. For example, circuitry associated with a thread device, routers, network element, etc. as described above in connection with one or more of the preceding figures may be configured to operate in accordance with one or more of the examples set forth below in the example section.

What is claimed is:

1. An apparatus for motion compensation in a video decoder, the apparatus comprising one or more electronic devices or processors configured to:
determine a first prediction signal representing an initial prediction P₁ for a current sub-block;
determine an additional prediction signal representing an additional hypothesis prediction hₙ₊₁ for the current sub-block;
perform a template matching based refinement process for a motion vector MV(h_(n+1)) used to obtain the additional hypothesis prediction hₙ₊₁ within a search area in a reference frame for a current template associated with the current sub-block until a best refinement of the additional hypothesis prediction h′ₙ₊₁=MC(TM(MV((h_(n+1)) is found according to an optimization measurement; and
derive an overall prediction signal Pₙ₊₁ by applying a sample-wise weighted superposition of at least the best refinement of the additional hypothesis prediction h′ₙ₊₁=MC(TM( [symbol] MV(h [symbol] ₙ₊₁))) based on a weighted superposition factor αₙ₊₁.

2. The apparatus of claim 1, wherein the first prediction signal comprises a uni-prediction signal or a bi-prediction signal.

3. The apparatus of claim 1, wherein the overall prediction signal Pₙ₊₁ is derived based on a sample-wise weighted superposition formula Pₙ₊₁=(1−αₙ₊₁) Pₙ+@n+1 h′ₙ₊₁, wherein h′ₙ₊₁ is obtained based on the best refinement of the MV used for the additional hypothesis prediction.

4. The apparatus of claim 1, wherein to derive the overall prediction signal, the one or more electronic devices or processors are configured to derive the overall prediction signal further based on applying bi-lateral filtering or pre-defined weights.

5. The apparatus of claim 1, wherein the one or more electronic devices or processors are configured to:
determining an additional prediction signal representing an additional hypothesis prediction hᵢ for the current sub-block;
performing the template matching based refinement process for a motion vector MV(h_i) used to obtain the additional hypothesis prediction hᵢ within the search area in the reference frame for the current template associated with the current sub-block until a best refinement of the other additional hypothesis motion vector TM(MV(hᵢ)) is found according to the optimization measurement; and
derive an overall prediction signal Pₙ₊₁ by applying a sample-wise weighted superposition of at least the best refinement of the additional hypothesis prediction h′ₙ₊₁ based on a weighted superposition factor @n+1, and an initial prediction Pₙ derived based on MC(TM( [symbol] MV(h [symbol] ᵢ))).

6. The apparatus of claim 1, wherein the optimization measurement comprises a sum of absolute differences (SAD) measurement or a sum of squared differences (SSD) measurement;
wherein the search area in the reference frame comprises a [−8, +8]-pel range of the reference frame; and
the current template associated with the current sub-block comprises a template including neighboring pixels above and at a left side of the current sub-block.
